(19) United States
(12) Patent Application Publication
(10) Pub. No.: US 2020/0178551 A1
(43) Pub. Date: Jun. 11, 2020

(54) STABILITY AND MOUTHFEEL ENHANCEMENT OF FORTIFIED, ASEPTICALLY PROCESSED BEVERAGES

(71) Applicant: NESTEC S.A., Vevey (CH)

(72) Inventors: Madansinh Nathusinh Vaghela, Macedonia, OH (US); Alexander Sher, Dublin, OH (US); Sherri Ann Siocum, Plymouth, MN (US); Joshua Reyo, Ramsey, MN (US)

(21) Appl. No.: 16/311,383

(22) PCT Filed: Jun. 21, 2017
(86) PCT No.: PCT/EP2017/065210

§ 371 Date: Dec. 19, 2018

Related U.S. Application Data
(60) Provisional application No. 62/355,456, filed on Jun. 28, 2016.

(51) Int. Cl. A23C 9/154; A23C 9/158; A23C 9/152

(52) U.S. Cl. CPC A23C 9/1544; A23C 9/1522; A23C 9/1526; A23C 9/158

(57) ABSTRACT

A fortified dairy-based ready-to-drink beverage includes a dairy component containing aggregates of kappa-casein covalently bonded to beta-lactoglobulin and having a particle size of 5 to 10 μm; and an amount of vitamins and minerals sufficient to provide fortification of the ready-to-drink beverage. The ready-to-drink beverage does not contain gum arabic; guar gum; xanthan gum; carrageenan; cellulose gum; an emulsifier; or a buffer. A method of making a fortified dairy-based ready-to-drink beverage includes forming a mixture by mixing a dairy component with an amount of vitamins and minerals sufficient to provide fortification of the ready-to-drink beverage; adjusting the pH of the mixture; homogenizing the pH-adjusted mixture; and subjecting the homogenized mixture to a heat treatment at 80-150° C. for 3 to 300 seconds. Neither the mixture nor the fortified dairy-based ready-to-drink beverage contains gum arabic; guar gum; xanthan gum; carrageenan; cellulose gum; an emulsifier; or a buffer.

### BACKGROUND

The present disclosure generally relates to ready-to-drink (“RTD”) beverages and methods for making such beverages. More specifically, the present disclosure relates to fortified dairy-based RTD beverages that comprise protein aggregates and optionally gellan gum and have an improved texture, mouthfeel and shelf-life stability without relying on carrageenan, cellulose gum, lecithin or potassium citrate.

An RTD beverage should be shelf-stable during storage without phase separation, creaming, gelation or sedimentation and should retain a constant viscosity over time. Emulsions and suspensions are thermodynamically unstable, thus there are challenges in overcoming physico-chemical instability issues during storage of dairy-based RTD beverages, which contain proteins, carbohydrates and fat and sometimes insoluble materials such as cocoa. This problem is especially difficult for RTD beverages which are not refrigerated.

Furthermore, vitamins and minerals are essential for the normal growth and development of humans, but the addition of these compounds to beverages can create a number of issues such as discoloration and/or an unpleasant texture and mouthfeel. Mineral fortification greatly impacts protein stability during processing and storage. For example, a high level of metal ions leads to destabilization of proteins (e.g., coagulation) in the beverage and to undesirable flavors. Moreover, insoluble sources of minerals such as calcium can precipitate out of the solution rapidly.

In addition to fortification of RTD beverages with micronutrients, consumers are looking for such beverages to have simple and natural ingredient formulations. However, RTD beverages typically require stabilizers to address the above-noted issues regarding product taste, texture and shelf-stability.

To stabilize the protein and suspend the minerals in fortified aseptically processed beverages during processing and storage (e.g., 12-18 month shelf life at ambient temperature), several known solutions use stabilizers such as gum arabic, guar gum, xanthan gum, carrageenan and cellulose gel along with emulsifiers such as lecithin. Also, pH adjustment with added buffers is used in fortified recipes to stabilize the protein and minimize sedimentation during storage. Processing steps involving multiple homogenization steps and complex heating, hydration and denaturation steps are employed to help to stabilize the protein and minimize sedimentation. Moreover, typical RTD beverages have complex formulations, for example having seventeen to twenty ingredients (not including the fortification).

### SUMMARY

The present inventors recognized that the above-noted compounds and processing steps can be disadvantageous and not aligned with consumer needs and desires. Therefore, the methods and compositions provided by the present disclosure maximize protein functionality by forming protein aggregates at a specific pH, without the use of potassium citrate or other buffering agents. These protein aggregates provide the stability to minimize sedimentation and creaming during storage. Gellan gum improves stability and may have synergistic effects with the protein aggregates.

Accordingly, in a general embodiment, the present disclosure provides a method of making a fortified dairy-based ready-to-drink beverage, the method comprising: forming a mixture by mixing a dairy component with an amount of vitamins and minerals sufficient to provide fortification of the ready-to-drink beverage; adjusting the pH of the mixture by adding a basic component; homogenizing the pH-adjusted mixture; and subjecting the homogenized mixture to a heat treatment at 80-150° C. for 3 to 300 seconds, neither the mixture nor the fortified dairy-based ready-to-drink beverage contains gum arabic; guar gum; xanthan gum; carrageenan; cellulose gum; an emulsifier such as lecithin; or a buffer such as citrates (e.g., potassium citrate), monophosphates, diphosphates, sodium monocarbonates, sodium bicarbonates, potassium monocarbonates, or potassium bicarbonates.

In an embodiment, the adjusting of the pH is performed such that the fortified dairy-based ready-to-drink beverage has a final pH of 6.4 to 6.7.

In an embodiment, the method comprises cooling the heat-treated mixture to a temperature below 25° C. and then aseptically filling the cooled mixture into an aseptic container.

In an embodiment, the mixture comprises high acyl gellan gum.

In an embodiment, the dairy component comprises an ingredient selected from the group consisting of skim milk, buttermilk, non-fat dry-milk, ultra-filtered milk, milk protein concentrate, milk protein isolate, and mixtures thereof. The dairy component can comprise skim milk and a skim milk concentrate (e.g., non-fat dry-milk, ultra-filtered milk, milk protein concentrate, and/or milk protein isolate), and in some embodiments the dairy component consists of these ingredients such that they are the only dairy ingredients in the beverage. The dairy component can further comprise at least one of whey protein, whey protein isolate, or whey protein concentrate. The dairy component can comprise fluid skim milk, non-fat dry milk, and at least one of whey protein, whey protein isolate, or whey protein concentrate, and in some embodiments the dairy component consists of these ingredients such that they are the only dairy ingredients in the beverage.

In an embodiment, the heat treatment subjects the homogenized mixture to a temperature of 136 to 150° C. for 3 to 15 seconds.

In an embodiment, the mixture contains casein and whey in a casein:whey ratio of 80:20 to 60:40.

In an embodiment, the mixture comprises a cocoa component.

In another embodiment, the present disclosure provides a fortified dairy-based ready-to-drink beverage comprising: a dairy component comprising aggregates of kappa-casein covalently bonded to beta-lactoglobulin and having a particle size of 5 to 10 μm; and an amount of vitamins and minerals sufficient to provide fortification of the ready-to-drink beverage, the ready-to-drink beverage does not contain gum arabic; guar gum; xanthan gum; carrageenan; cellulose gum; an emulsifier such as lecithin; or a buffer such as citrates (e.g., potassium citrate), monophosphates, diphosphates, sodium monocarbonates, sodium bicarbonates, potassium monocarbonates, or potassium bicarbonates.

In an embodiment, the ready-to-drink beverage is shelf-stable for at least twelve months at ambient temperature, preferably at least fifteen months at ambient temperature, most preferably at least eighteen months at ambient temperature.

In an embodiment, the ready-to-drink beverage further comprises high acyl gellan gum.

In an embodiment, the ready-to-drink beverage comprises at least about 4 wt. % protein. The ready-to-drink beverage can comprise at least about 6 wt. % protein in some embodiments.

In an embodiment, the ready-to-drink beverage further comprises a cocoa component.

In an embodiment, the ready-to-drink beverage has a final pH of 6.4 to 6.7.

In an embodiment, the aggregates are formed by a process comprising adjusting the pH of a mixture comprising a dairy component, homogenizing the pH-adjusted mixture, and subjecting the homogenized mixture to a heat treatment at 80-150° C. for 3 to 300 seconds.

In an embodiment, the ready-to-drink beverage contains not greater than ten ingredients other than the vitamins and minerals that provide the fortification.

In another embodiment, the present disclosure provides a method of providing nutrition to an individual. The method comprises administering to the individual a fortified dairy-based ready-to-drink beverage that (i) comprises a dairy component comprising aggregates of kappa-casein covalently bonded to beta-lactoglobulin and having a particle size of 5 to 10 μm, (ii) comprises an amount of vitamins and minerals sufficient to provide fortification of the ready-to-drink beverage, and (iii) does not contain gum arabic, guar gum, xanthan gum, carrageenan, cellulose gum, an emulsifier or a buffer.

In an embodiment, the fortified dairy-based ready-to-drink beverage is administered to the individual in a single serving having a nutritional profile selected from the group consisting of: (i) 50%-200% of the Daily Value (DV) of one or more of Vitamin C, Vitamin E, Vitamin K, Thiamin, Riboflavin, Vitamin B6, Calcium, Phosphorus, Iron, Iodine, Selenium and Manganese; (ii) 25%-200% of the DV of one or more of Vitamin A, Vitamin D, Niacin, Biotin, Folic Acid, Pantothenic Acid, Vitamin B12, Choline, Copper, Zinc, Magnesium, Chromium and Molybdenum; (iii) 10%-200% of the DV of Potassium; and (iv) combinations thereof.

In an embodiment, a single serving of the fortified beverage has a volume from about 4 fl oz (about 118 ml) to about 12 fl oz (about 355 ml).

An advantage of one or more embodiments provided by the present disclosure is to provide shelf shelf-life stability of fortified aseptically processed dairy-based beverages without the use of carrageenan or cellulose gum.

Another advantage of one or more embodiments provided by the present disclosure is to use protein aggregates formed during processing to provide shelf-life stability of fortified aseptically processed dairy-based beverages and also improve the mouthfeel perception of reduced solids products.

Yet another advantage of one or more embodiments provided by the present disclosure is to use protein aggregates formed during processing to improve the mouthfeel perception of reduced solids products.

An additional advantage of one or more embodiments provided by the present disclosure is to simplify the recipe of fortified aseptically processed dairy-based beverages by removing the stabilizers, emulsifiers and buffers.

Still another advantage of one or more embodiments provided by the present disclosure is to use more natural ingredients in fortified aseptically processed dairy-based beverages.

Another advantage of one or more embodiments provided by the present disclosure is to provide a RTD product aligned with consumer needs.

Yet another advantage of one or more embodiments provided by the present disclosure is to simplify the processing steps for mixing and thermal-processing of fortified aseptically processed dairy-based beverages.

An additional advantage of one or more embodiments provided by the present disclosure is to enable development of fortified aseptically processed dairy-based beverages with fewer ingredients, e.g., nine or ten ingredients not including the fortification.

Still another advantage of one or more embodiments provided by the present disclosure is to enable addition of whole grains and use of fluid milk or non-fat dry milk in fortified aseptically processed dairy-based beverages instead of milk protein concentrate and caseinates.

Another advantage of one or more embodiments provided by the present disclosure is to use fluid milk with non-fat dry milk to increase the protein of an RTD beverage, for example at least about 10 g per 8 oz., while providing vitamins and minerals, for example at least 21 different vitamins or minerals.

Yet another advantage of one or more embodiments provided by the present disclosure is to at least partially replace milk protein concentrate and/or soy protein isolate in an RTD beverage with fluid milk (e.g., fluid skim milk) and/or non-fat dry milk.

An additional advantage of one or more embodiments provided by the present disclosure is to use gellan gum to replace cellulose gel and gum, soy lecithin, and carrageenan in an RTD beverage.

Still another advantage of one or more embodiments provided by the present disclosure is an RTD beverage for which milk is the primary ingredient (i.e., largest by volume and/or weight).

Another advantage of one or more embodiments provided by the present disclosure is a milk-based RTD recipe that provides a ratio of casein to whey protein particularly suitable for formation of protein aggregates that stabilize the resultant beverage.

Additional features and advantages are described in, and will be apparent from, the following Detailed Description and the Figures.

### BRIEF DESCRIPTION OF DRAWINGS

FIG. 1 shows a flowchart of an embodiment of a method of making a shelf-stable fortified dairy-based RTD beverage provided by the present disclosure.

FIGS. 2-5 are graphs showing particle size distribution for fortified dairy-based RTD beverages made using heat treatment at various pHs.

FIGS. 6 and 7 are graphs showing viscosities of fortified dairy-based RTD beverages made using heat treatment at optimum pH and optionally high acyl gellan gum.

### DETAILED DESCRIPTION

### Definitions

Some definitions are provided hereafter. Nevertheless, definitions may be located in the “Embodiments” section below, and the above header “Definitions” does not mean that such disclosures in the “Embodiments” section are not definitions.

All percentages are by weight of the total weight of the composition unless expressed otherwise. Similarly, all ratios are by weight unless expressed otherwise. “Dry weight” is the weight excluding water. “Ambient temperature” is 25° C. When reference is made to the pH, values correspond to pH measured at ambient temperature with standard equipment.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used herein and in the appended claims, the singular form of a word includes the plural, unless the context clearly dictates otherwise. Thus, the references “a,” “an” and “the” are generally inclusive of the plurals of the respective terms. For example, reference to “an ingredient” or “a method” includes a plurality of such “ingredients” or “methods.” The term “and/or” used in the context of “X and/or Y” should be interpreted as “X,” or “Y,” or “X and Y.”

Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of” and “consisting of” the disclosed components or steps. The term “consisting essentially” means that the referenced components are at least 75% of the composition, preferably at least 85% of the composition, more preferably at least 95% of the composition, and most preferably at least 99% of the composition.

Where used herein, the term “example,” particularly when followed by a listing of terms, is merely exemplary and illustrative, and should not be deemed to be exclusive or comprehensive. Any embodiment disclosed herein can be combined with any other embodiment disclosed herein unless explicitly indicated otherwise.

The terms “food,” “food product” and “food composition” mean a product or composition that is intended for ingestion by an individual such as a human and provides at least one nutrient to the individual. The compositions of the present disclosure, including the many embodiments described herein, can comprise, consist of, or consist essentially of the essential elements and limitations described herein, as well as any additional or optional ingredients, components, or limitations described herein or otherwise useful in a diet.

The relative terms “improved,” “increased,” “enhanced” and the like in the context of texture, mouthfeel and/or shelf-stability refer to the effects of the fortified dairy-based RTD formulation disclosed herein, e.g., a formulation comprising protein aggregates and optionally gellan gum, relative to a composition lacking protein aggregates and gellan gum but otherwise identical.

A “ready to drink” or “RTD” beverage is a beverage in liquid form that can be consumed without further addition of liquid and preferably is aseptic. “Shelf-stable” means that the beverage can be stored at ambient temperatures without compromising product stability (e.g., without phase separation, creaming, gelation, sedimentation or loss of viscosity) for at least twelve months, preferably at least fifteen months, most preferably at least eighteen months.

As used herein, “fortification” of a beverage and a “fortified” beverage mean that a single serving of the beverage contains at least 20% of the Daily Value (DV) of Vitamin C, Vitamin E, Vitamin K, Thiamin, Riboflavin, Vitamin B6, Calcium, Phosphorus, Iron, Iodine, Selenium and Manganese; at least 10% of the DV of Vitamin A, Vitamin D, Niacin, Biotin, Folic Acid, Pantothenic Acid, Vitamin B12, Choline, Copper, Zinc, Magnesium, Chromium and Molybdenum; at least 5% of the DV of Potassium; and at most 200% of the DV for each of these vitamins and minerals.

In some embodiments, a single serving of the fortified beverage can contain at least 50% of the DV (e.g., at least 100% of the DV) of one or more of Vitamin C, Vitamin E, Vitamin K, Thiamin, Riboflavin, Vitamin B6, Calcium, Phosphorus, Iron, Iodine, Selenium and Manganese; and/or at least 25% of the DV (e.g., at least 50% of the DV or at least 100% of the DV) of one or more of Vitamin A, Vitamin D, Niacin, Biotin, Folic Acid, Pantothenic Acid, Vitamin B12, Choline, Copper, Zinc, Magnesium, Chromium and Molybdenum; and/or at least 10% of the DV (e.g., at least 15% of the DV or at least 20% of the DV) of Potassium. In some embodiments, a single serving of the fortified beverage contains less than 150% of the DV of one or more of these vitamins and minerals, for example less than 125% of the DV of one or more of these vitamins and minerals.

The DV of each of these vitamins and minerals is established by Title 21 of the Code of Federal Regulations, Volume 2 (revised Apr. 1, 2015), Chapter I, Subchapter B, Part 101, Subpart A, Section 101.9 (“Nutrition labeling of food”), subsection (c)(8)(iv). In this regard, the DV is established for the vitamins and minerals as follows:

Vitamin A, 5,000 International Units

Vitamin C, 60 milligrams

Calcium, 1,000 milligrams

Iron, 18 milligrams

Vitamin D, 400 International Units

Vitamin E, 30 International Units

Vitamin K, 80 micrograms

Thiamin, 1.5 milligrams

Riboflavin, 1.7 milligrams

Niacin, 20 milligrams

Vitamin B6, 2.0 milligrams

Folate, 400 micrograms

Vitamin B12, 6 micrograms

Biotin, 300 micrograms

Pantothenic acid, 10 milligrams

Phosphorus, 1,000 milligrams

Iodine, 150 micrograms

Magnesium, 400 milligrams

Zinc, 15 milligrams

Selenium, 70 micrograms

Copper, 2.0 milligrams

Manganese, 2.0 milligrams

Chromium, 120 micrograms

Molybdenum, 75 micrograms

Chloride, 3,400 milligrams

### Embodiments

An aspect of the present disclosure is a fortified dairy-based RTD beverage. Another aspect of the present disclosure is a method of making a fortified dairy-based RTD beverage. Yet another aspect of the present disclosure is a method of providing nutrition to an individual, the method comprising administering a fortified dairy-based RTD beverage to the individual. The fortified dairy-based RTD beverages do not contain any gum arabic; guar gum; xanthan gum; carrageenan; cellulose gum; an emulsifier such as lecithin; or a buffer such as citrates (e.g., potassium citrate), monophosphates, diphosphates, sodium monocarbonates, sodium bicarbonates, potassium monocarbonates, or potassium bicarbonates.

Without being bound by any theory, the present inventors believe that a controlled aggregation of casein micelles and whey can be achieved by adjusting the pH followed by heat treatment (at a specific time and temperature combination) of the unfolded proteins for aggregation thereof. The aggregates can comprise kappa-casein covalently bonded to beta-lactoglobulin and can have a particle size of 5 to 10 μm. The resultant protein network increases the viscosity of the beverage and in turn improves the mouthfeel thereof, and further decreases the need for a texturizer. For example, the combination of heat and additional basic compounds causes the milk casein to destabilize and denature to allow formation of aggregates with whey proteins. A controlled aggregation forms a network that entraps water and fat globules causing an increase in viscosity.

The fortified RTD beverage comprises a dairy component that preferably comprises skim milk, for example fluid skim milk and/or non-fat dry skim milk. In an embodiment, the dairy component is the primary ingredient (i.e., largest by volume and/or weight). For example, the dairy component is preferably present in the fortified RTD beverage in the largest amount relative to any other ingredient.

In an embodiment, the non-fat dry milk provides about 37.5 to 100.0 wt. % of the protein of the fortified RTD beverage, and the fluid milk provides up to about 62.5 wt. % of the protein of the beverage (e.g., about 0.0 wt. % if the non-fat dry milk is the only dairy source). In an embodiment, the fortified dairy-based RTD beverage comprises about 4.0 wt. % protein. In an embodiment in which the fortified dairy-based RTD beverage is maximized for a high protein content such as about 6 wt. % protein, the non-fat dry milk preferably provides about 60.0 wt. % of the protein, and the fluid milk provides about 40.0 wt. % of the protein.

Nevertheless, the dairy component can additionally or alternatively comprise one or more of ultra-filtered milk, buttermilk, milk-protein concentrate, milk protein isolate, whey, whey protein isolate, or whey protein concentrate.

In an embodiment, the dairy component can comprise skim milk and skim milk concentrate (e.g., non-fat dry-milk, ultra-filtered milk, milk protein concentrate, and/or milk protein isolate), and in some embodiments the dairy component consists of these ingredients such that they are the only dairy ingredients in the beverage. In an embodiment, the dairy component can comprise fluid skim milk, non-fat dry milk, and at least one of whey protein, whey protein isolate, or whey protein concentrate, and in some embodiments the dairy component consists of these ingredients such that they are the only dairy ingredients in the beverage.

The dairy component can comprise casein and whey proteins in a casein:whey ratio of 80:20 to 60:40, preferably about 70:30.

In an embodiment, the fortified dairy-based RTD beverage further comprises high acyl gellan gum. The molecular structure of gellan gum is a straight chain based on repeating glucose, rhamnose, and glucuronic acid units. High acyl gellan gum has two acyl substituents being acetate and glycerate. Both substituents are located on the same glucose residue, and on average, there is one glycerate per repeat and one acetate per every two repeats. The amount of a high acyl gellan gum in the RTD beverage can be from 0.03 to 0.15 wt. % by weight, preferably 0.07 to 0.1 wt. %.

The high acyl gellan gum can synergistically assist the protein aggregates in maintaining good suspension and emulsion stability; avoiding gelation, sedimentation, syneresis and other phase separation issues during storage; and improving mouthfeel. In an embodiment, any gellan gum is the only hydrocolloid in the beverage; for example, if the beverage does not contain high acyl gellan gum, the beverage does not contain any hydrocolloids in this embodiment.

In a preferred embodiment, the fortification of the dairy-based RTD beverage comprises one or more of Biotin, Calcium, Chloride, Choline, Copper, Folic Acid, Iodine, Iron, Magnesium, Manganese, Sodium, Phosphorus, Potassium, Vitamin A, Vitamin B1, Vitamin B2, Vitamin B3, Vitamin B5, Vitamin B6, Vitamin B12, Vitamin C, Vitamin D, Vitamin E, Vitamin K, or Zinc. In some embodiments, the fortification comprises one or more of Selenium, Molybdenum, or Chromium.

In a preferred embodiment, a single serving of the fortified beverage has a volume from about 4 fl oz (or about 118 ml) to about 12 fl oz (or about 355 ml). In some embodiments a single serving of the fortified beverage has a volume from about 6 fl oz (or about 177 ml) to about 12 fl oz (or about 237 ml). In an embodiment, a single serving of the fortified beverage has a volume of about 8 fl oz. In another embodiment, a single serving of the fortified beverage has a volume of about 11 fl oz.

The fortified dairy-based RTD beverage can comprise a cocoa component. The cocoa component can include one or more natural cocoas, alkalized cocoas, or other cocoa- or chocolate-based products. Additionally or alternatively, the beverage can comprise a flavor ingredient such as one or more of vanilla, fruit flavor (e.g., banana, strawberry and/or raspberry), coffee or tea.

In a preferred embodiment, the fortified dairy-based RTD beverage is aseptically processed to avoid or minimize spoiling. Aseptic treatment of the beverage may be performed by pre-heating the beverage, for example to about 75 to 85° C., and then injecting steam into the beverage to raise the temperature to about 140 to 160° C., for example at about 150° C. The beverage may then be cooled, for example by flash cooling, to a temperature of about 75 to 85° C., further cooled to about room temperature and filled into containers, such as cans or bottles. Suitable apparatuses for aseptic treatment of the beverage are commercially available.

In an embodiment, the fortified dairy-based RTD beverage comprises a sugar (e.g., invert sugar, sucrose, fructose, glucose, or any mixture thereof), a natural sweetener, an artificial sweetener, or any combination thereof. For example, the fortified dairy-based RTD beverage can comprise one or more of a sugar, corn syrup and stevia.

The fortified dairy-based RTD beverage may comprise fat and/or oil, for example milk fat as part of milk solids and/or vegetable oil such as coconut oil, soy oil, palm oil, canola oil, corn oil, safflower oil, and/or sunflower oil.

Preferably the fortified dairy-based RTD beverage contains not greater than ten ingredients other than the vitamins and minerals that provide the fortification, and in some embodiments not greater than nine ingredients other than the vitamins and minerals that provide the fortification. In an embodiment, the fortified dairy-based RTD beverage consists essentially of (i) skim milk (e.g., fluid skim milk and/or not fat dry milk), (ii) corn syrup, (iii) sugar, (iv) salt, (v) natural flavor, (vi) stevia, (vii) canola oil, (viii) a cocoa component, (ix) gellan gum, and (x) the fortification vitamins and minerals. In an embodiment, the fortified dairy-based RTD beverage consists of these ingredients.

In an embodiment, the fortified dairy-based RTD beverage comprises a whole grain component. For example, the fortified dairy-based RTD beverage can comprise a hydrolyzed whole grain composition, which is a whole grain component enzymatically digested by using at least an alpha-amylase. The hydrolyzed whole grain composition is preferably further digested by the use of a protease. Whole grain components are components made from unrefined cereal grains. Whole grain components comprise the entire edible parts of a grain; i.e. the germ, the endosperm and the bran. Whole grain components may be provided in a variety of forms such as ground, flaked, cracked or other forms, as is commonly known in the milling industry. Optionally the whole grain components are concentrated and dried after hydrolysis.

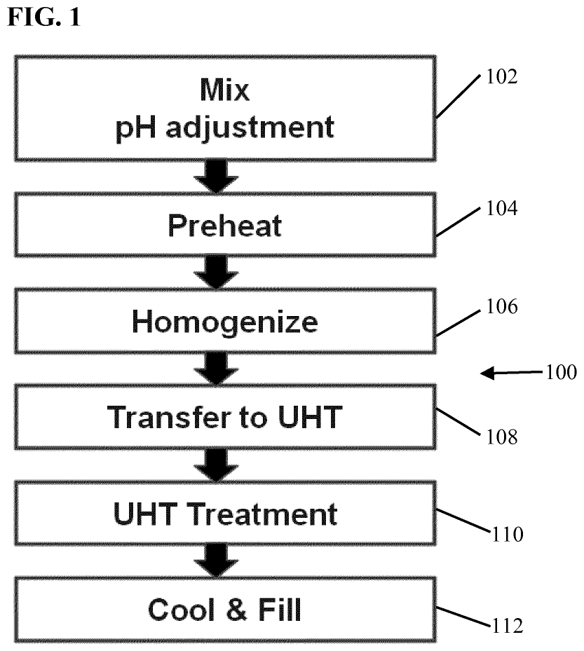

FIG. 1 generally illustrates a non-limiting example of an embodiment of a method 100 of making a fortified dairy-based RTD beverage. The method 100 can comprise mixing the milk (e.g., skim milk and/or non-fat dry milk), the vitamins and minerals employed in the fortification, and the other ingredients; and adjusting the pH of the mixture, as shown in Step 102. Adjusting the pH of the mixture preferably comprises adding a basic component to the mixture. Non-limiting examples of suitable basic components include potassium hydroxide, sodium hydroxide, potassium bicarbonate, and mixtures thereof. Preferably an amount of the basic component is added such that the final pH of the beverage is 6.4 to 6.7.

In an embodiment, the solids content of the mixture can be adjusted to a desired level, for example by adding water.

In Step 104, the mixture can undergo pre-heating, for example heating to a temperature of about 70° C.

In Step 106, the pre-heated mixture can be homogenized. For example, the mixture can be homogenized at a pressure between 35 and 135 bars.

In Step 108, the homogenized mixture can be transferred from the homogenizer to a heating device. In Step 110, the homogenized mixture can be subjected to heat treatment at 80-150° C. for 3 to 300 seconds, preferably UHT conditions at 136-150° C. for 3-15 seconds. Preferably there is no homogenization after the heat treatment. For example, the homogenization in Step 106 can be the only homogenization of the mixture.

The heat treatment can create the protein aggregates and thus form the fortified dairy-based RTD beverage having enhanced mouthfeel and shelf-life stability. In an embodiment, the protein aggregates have an average particle size of 5 to 10 μm. The protein aggregates comprise kappa-casein covalently bonded to beta-lactoglobulin. As used herein, “particle size” refers to the mean diameter. Specifically, the particle size was measured herein as the volume-based mean diameter using laser diffraction. For example, the volume-based mean diameter can be measured using a Malvern Mastersizer 2000 granulometer (Malvern Instruments Ltd, UK).

In Step 112, the fortified dairy-based RTD beverage can be cooled to a temperature below 70° C., preferably below 60° C. or below, more preferably to 25° C. or below; and filled aseptically into aseptic containers such as bottles or cans.

### Examples

The following non-limiting examples present scientific data developing and supporting the concept of fortified dairy-based RTD beverages that comprise protein aggregates and optionally gellan gum and have an improved texture, mouthfeel and shelf-life stability without relying on gum arabic; guar gum; xanthan gum; carrageenan; cellulose gum; an emulsifier such as lecithin; or a buffer such as citrates (e.g., potassium citrate), monophosphates, diphosphates, sodium monocarbonates, sodium bicarbonates, potassium monocarbonates, or potassium bicarbonates.

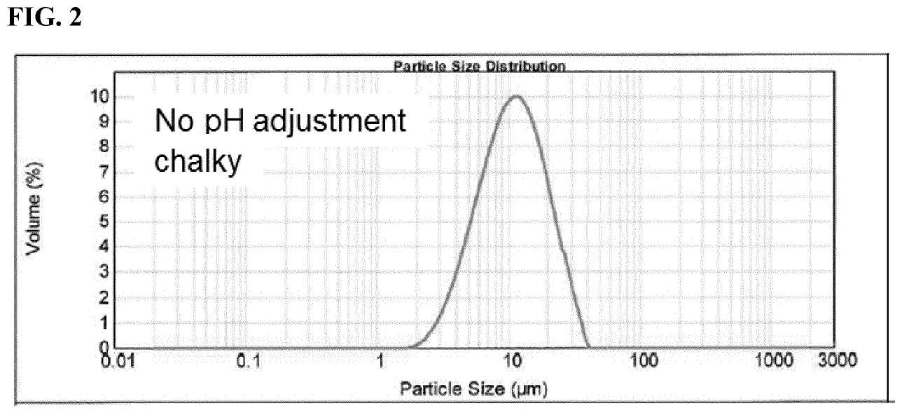

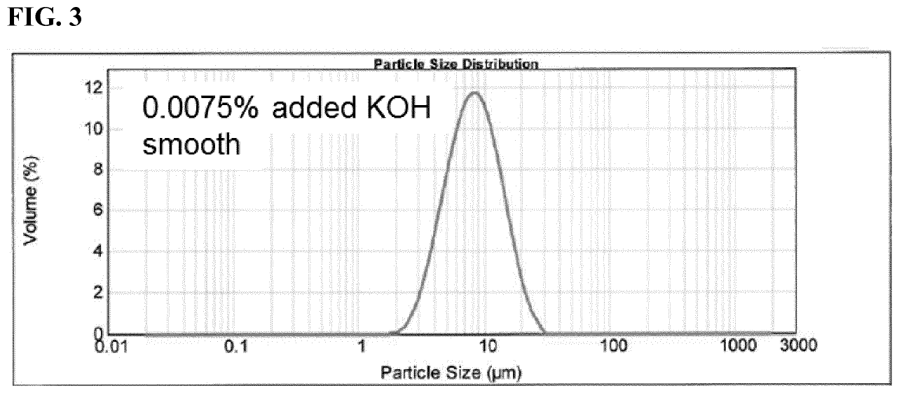

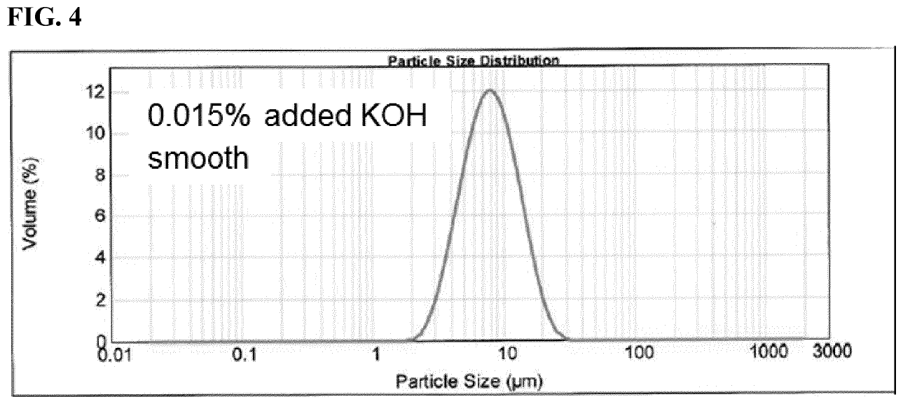

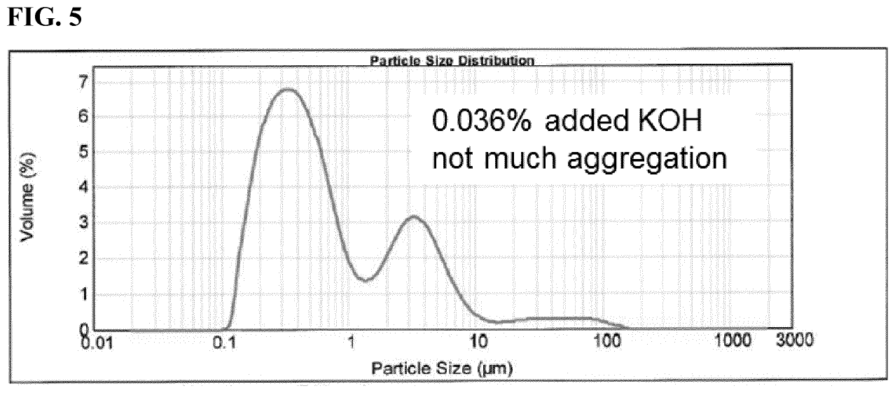

Particle size analysis was performed on both control and treated samples in order to show the effect of the treatment on the protein denaturation. FIG. 2 shows the particle size distribution for heat treatment with no added basic component; FIG. 3 shows the particle size distribution for heat treatment with 0.0075 wt. % potassium hydroxide added; FIG. 4 shows the particle size distribution for heat treatment with 0.015 wt. % potassium hydroxide added; and FIG. 5 shows the particle size distribution for heat treatment with 0.036% potassium hydroxide added.

As shown in these figures, samples with addition of a basic component showed a shift in the peak of particle size. This shift indicates that the heat treatment under these conditions for a specific time caused a partial denaturation of the proteins. Nevertheless, the sample with no pH adjustment had a chalky mouthfeel. In contrast, the samples with 0.0075 wt. %-0.015 wt. % potassium hydroxide had a smooth mouthfeel indicating that the partial denaturation of the protein affects the organoleptic properties of the beverage.

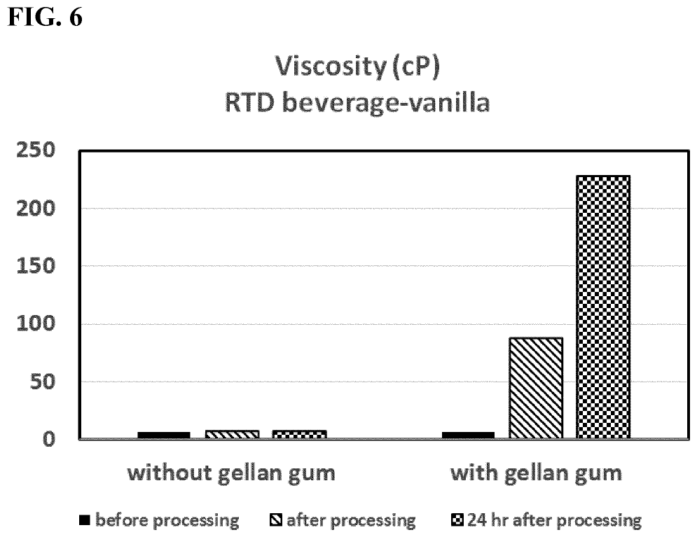

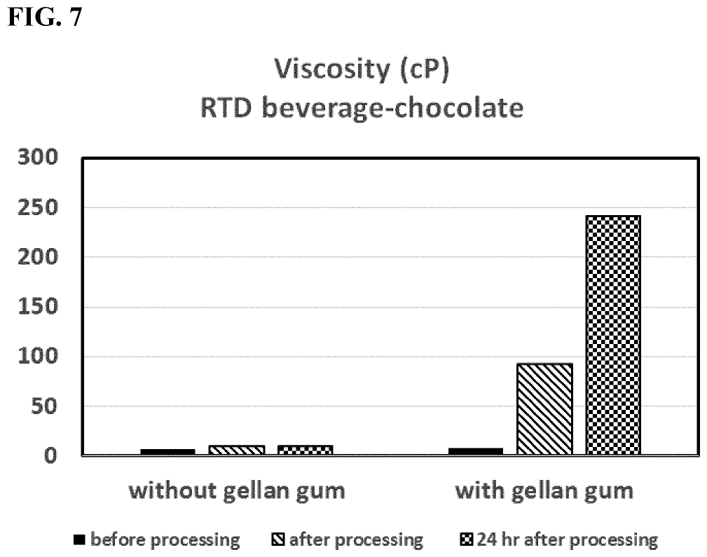

FIG. 6 shows the viscosity of fortified vanilla-flavored dairy-based RTD beverages resulting from heat treatment with and without the addition of 0.12 wt. % high acyl gellan gum. FIG. 7 shows the viscosity of fortified chocolate-flavored dairy-based RTD beverages resulting from heat treatment with and without the addition of 0.12% high acyl gellan gum.

As shown in these figures, the viscosity increases of beverages containing both protein aggregates and high acyl gellan gum show a synergistic affect between these two compounds.

As shown in these figures, the shelf-life stability of beverages containing both protein aggregates and gellan gum further supports a synergistic affect between these two compounds.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of making a fortified dairy-based ready-to-drink beverage, the method comprising:
forming a mixture by mixing a dairy component with an amount of vitamins and minerals sufficient to provide fortification of the ready-to-drink beverage;
adjusting the pH of the mixture by adding a basic component;
homogenizing the pH-adjusted mixture; and
subjecting the homogenized mixture to a heat treatment at 80-150° C. for 3 to 300 seconds,
neither the mixture nor the fortified dairy-based ready-to-drink beverage contains gum arabic, guar gum, xanthan gum, carrageenan, cellulose gum, an emulsifier or a buffer.

2. The method of claim 1, wherein the adjusting of the pH is performed such that the fortified dairy-based ready-to-drink beverage has a final pH of 6.4 to 6.7.

3. The method of claim 1, comprising cooling the heat-treated mixture to a temperature below 25° C. and then aseptically filling the cooled mixture into an aseptic container.

4. The method of claim 1, wherein the mixture comprises high acyl gellan gum.

5. The method of claim 1, wherein the dairy component comprises an ingredient selected from the group consisting of skim milk, buttermilk, ultra-filtered milk, milk protein concentrate, milk protein isolate, non-fat dry milk, and mixtures thereof.

6-9. (canceled)

10. The method of claim 1, wherein the heat treatment subjects the homogenized mixture to a temperature of 136 to 150° C. for 3 to 15 seconds.

11. The method of claim 1, wherein the mixture contains casein and whey in a casein:whey ratio of 80:20 to 60:40.

12. The method of claim 1, wherein the mixture comprises a cocoa component.

13. (canceled)

14. A fortified dairy-based ready-to-drink beverage comprising:
a dairy component comprising aggregates of kappa-casein covalently bonded to beta-lactoglobulin and having a particle size of 5 to 10 μm; and
an amount of vitamins and minerals sufficient to provide fortification of the ready-to-drink beverage,
the ready-to-drink beverage does not contain gum arabic, guar gum, xanthan gum, carrageenan, cellulose gum, an emulsifier or a buffer.

15. The ready-to-drink beverage of claim 14, which is shelf-stable for at least one year at ambient temperature.

16. The ready-to-drink beverage of claim 14, further comprising high acyl gellan gum.

17. The ready-to-drink beverage of claim 14, comprising at least about 4 wt. % protein.

18. The ready-to-drink beverage of claim 14, further comprising a cocoa component.

19. The ready-to-drink beverage of claim 14, having a pH of 6.4 to 6.7.

20. The ready-to-drink beverage of claim 14, wherein the aggregates are formed by a process comprising adjusting the pH of a mixture comprising a dairy component, homogenizing the pH-adjusted mixture, and subjecting the homogenized mixture to a heat treatment at 80-150° C. for 3 to 300 seconds.

21. The ready-to-drink beverage of claim 14, which contains not greater than ten ingredients other than vitamins and minerals that provide the fortification.

22. (canceled)

23. A method of providing nutrition to an individual, the method comprising administering to the individual a fortified dairy-based ready-to-drink beverage that (i) comprises a dairy component comprising aggregates of kappa-casein covalently bonded to beta-lactoglobulin and having a particle size of 5 to 10 μm, (ii) comprises an amount of vitamins and minerals sufficient to provide fortification of the ready-to-drink beverage, and (iii) does not contain gum arabic, guar gum, xanthan gum, carrageenan, cellulose gum, an emulsifier or a buffer.

24. The method of claim 23, wherein the ready-to-drink beverage has a pH of 6.4 to 6.7.

25. The method of claim 23, wherein the fortified dairy-based ready-to-drink beverage is administered to the individual in a single serving having a nutritional profile selected from the group consisting of:
(i) 50%-200% of the Daily Value (DV) of one or more of Vitamin C, Vitamin E, Vitamin K, Thiamin, Riboflavin, Vitamin B6, Calcium, Phosphorus, Iron, Iodine, Selenium and Manganese;
(ii) 25%-200% of the DV of one or more of Vitamin A, Vitamin D, Niacin, Biotin, Folic Acid, Pantothenic Acid, Vitamin B12, Choline, Copper, Zinc, Magnesium, Chromium and Molybdenum;
(iii) 10%-200% of the DV of Potassium; and
(iv) combinations thereof.

26. (canceled)
